(19) United States
(12) Patent Application Publication
(10) Pub. No.: US 2021/0178558 A1
(43) Pub. Date: Jun. 17, 2021

(54) SCREW

(71) Applicant: Chun-ming HUANG, Chunghua County (TW)

(72) Inventor: Chun-Ming HUANG, Changhua County (TW)

(21) Appl. No.: 16/715,641

(22) Filed: Dec. 16, 2019

(51) Int. Cl. B25B 15/00; F16B 23/00

(52) U.S. Cl. CPC B25B 15/005; B25B 15/008; F16B 23/0023; B25B 15/007

(57) ABSTRACT

Provided is a screw. A recess portion is formed at an end of the screw by extending a depth along a central axis direction of the screw. A tool matching structure is formed on a bottom surface of the recess portion for providing a tool that enters into the recess portion so as to make a part of the tool and the tool matching structure be matched to each other, thereby operating the tool to drive the screw for rotating.

### BACKGROUND OF THE INVENTION

### 1. Field of the Invention

The present invention relates to a mechanical fastening member for spirally fixing objects.

### 2. The Prior Arts

FIGS. 1 to 3 show the structure and use of a conventional hexagonal screw A having a head portion; and FIGS. 4 and 5 show the structure of a conventional hexagonal screw B without a head portion. In the hexagonal screw A shown in FIGS. 1 and 2, a head portion A2 that has an outer diameter larger than that of a spiral portion A1 is formed at one end of the spiral portion A1, and a recess portion A3 is formed at an end of the head portion A2 by extending a depth along a central axis direction of the screw. The cross-sectional profile of the recess portion A3 is formed in a hexagonal shape so that it may be operated with a hexagonal wrench. For example, two objects C may be fixed to each other. The screw A is commonly referred to as a hexagonal screw.

The hexagonal screw B shown in FIGS. 4 and 5 includes a spiral portion B1 with a whole uniform diameter, and a recess portion B2 is formed at one end of the spiral portion B1 by extending a depth along a central axis direction of the screw. The cross-sectional profile of the recess portion B2 is formed in a hexagonal shape so that it may be operated with a hexagonal wrench. The screw B is also commonly referred to as a hexagonal screw.

The cross-sectional profile of the recess portions A3, B2 of the aforementioned hexagonal screw A or B may also be formed in a star shape or other geometric shapes for use in cooperation with a star wrench or other special tools.

Since tools such as hexagonal wrenches or star wrenches are mostly designed in an L shape to provide a larger torque to tighten or loosen screws during a user's operation, it is not easy to apply a smaller torque to finely adjust the screws. In addition, the recess portion on the hexagonal screw or the star screw may be worn or collapsed due to improper matching with the tool. In this case, the matching of the hexagonal wrenches or the star wrenches with the recess portion will cause a large error. Therefore, it is more difficult to smoothly fine-tune the screw, or it may not even smoothly tighten or loosen the screw.

### SUMMARY OF THE INVENTION

An objective of the present invention is to provide an improved screw such that even if a recess portion formed on the screw for cooperation with a tool that is worn or collapsed, other tools may be used instead of rotating the screw.

Another objective of the present invention is to provide an improved screw such that the screw may be adapted to rotate with a large torque and a small torque in cooperation with different tools, and the rotation of the small torque is suitable for fine adjusting the screw.

The screw provided by the present invention is formed with a recess portion at an end surface thereof by extending a depth along a central axis direction of the screw, and a tool matching structure is formed on a bottom surface of the recess portion. After a tool enters into the recess portion, a part of the tool and the tool matching structure are matched to each other, thereby operating the tool to drive the screw for rotating.

In one embodiment of the present invention, one end of the screw may have a head portion. The recess portion is formed by extending the depth from an end surface of the head portion along a central axis direction of the screw. Thereby, after at least two objects are locked to each other by the screw, the head portion may protrude from a surface of the object or the head portion is sunk into a buried hole provided by the object.

In one embodiment of the present invention, the cross-sectional profile of the recess portion may be formed in a polygonal shape for cooperation with a tool having a corresponding shape for matching operation.

In one embodiment of the present invention, the cross-sectional profile of the recess portion may be formed in a hexagonal shape to form a hexagonal screw for matching operation with a hexagonal wrench.

In one embodiment of the present invention, the cross-sectional profile of the recess portion may be formed in a star shape for cooperation with a tool having a corresponding star shape for matching operation.

In one embodiment of the present invention, the tool matching structure may be a groove recessed from the bottom surface of the recess portion or a protrusion protruding from the bottom surface for cooperation with a tool having a correspondingly shaped protrusion or recess portion for matching operation.

In one embodiment of the present invention, the tool matching structure may be formed in a linear shape. When the tool matching structure is a linear groove, it may be operated in matching with a flat-head screwdriver; when the tool matching structure is a linear protrusion, it may be operated in matching with a tool having a recess portion of a flat-head shape.

In one embodiment of the present invention, the tool matching structure may be formed in a cross shape. When the tool matching structure is a cross groove, it may be operated in matching with a cross screwdriver; when the tool matching structure is a cross projection, it may be operated in matching with a tool having a cross recess portion.

In one embodiment of the present invention, the tool matching structure may be formed in a groove or a protrusion having a polygonal shape in the axial direction of the screw to be operated in matching with a tool having a correspondingly shaped protrusion or recess portion.

According to the above-mentioned improved screw of the present invention, even when the recess portion formed on the screw for cooperation with a tool is worn or collapsed and cannot be operated by the tool, it is also possible to use another tool such as a screwdriver to replace the tool to drive the screw 1 for rotating. Also, the screw of the present invention is suitable for fine-tuning the screw.

### BRIEF DESCRIPTION OF THE DRAWINGS

The present invention is further described below in conjunction with the accompanying drawings and embodiments.

FIG. 1 is a perspective view showing a conventional screw having a head portion;

FIG. 2 is a perspective cross-sectional view showing the conventional screw structure having the head portion;

FIG. 3 is a plan sectional view showing the conventional screw having the head portion fixing two objects together;

FIG. 4 is a perspective view showing a conventional screw without a head portion;

FIG. 5 is a perspective cross-sectional view showing a conventional screw structure without a head portion;

FIGS. 6A and 6B are respectively a perspective view and a perspective cross-sectional view showing a groove having a linear shape is formed on the bottom surface of the recess portion of the screw that has a head portion according to an embodiment of the present invention;

FIGS. 7A and 7B are respectively a perspective view and a perspective cross-sectional view showing a linear protrusion is formed on the bottom surface of the recess portion of the screw that has a head portion according to an embodiment of the present invention;

FIGS. 8A and 8B are respectively a perspective view and a perspective cross-sectional view showing a groove having a linear shape is formed on the bottom surface of the recess portion of the screw that has no head portion according to an embodiment of the present invention;

FIGS. 9A and 9B are respectively a perspective view and a perspective cross-sectional view showing a linear protrusion is formed on the bottom surface of the recess portion of the screw that has no head portion according to an embodiment of the present invention;

FIG. 10A is a partial perspective view showing a groove having a polygonal shape is formed on the bottom surface of the recess portion of the screw according to an embodiment of the present invention;

FIG. 10B is a partial perspective view showing a projection having a polygonal shape is formed on the bottom surface of the recess portion of the screw according to an embodiment of the present invention;

FIG. 11A is a partial perspective view showing a groove having a cross shape is formed on the bottom surface of the recess portion of the screw according to an embodiment of the present invention; and

FIG. 11B is a partial perspective view showing a projection having a cross shape is formed on the bottom surface of the recess portion of the screw according to an embodiment of the present invention.

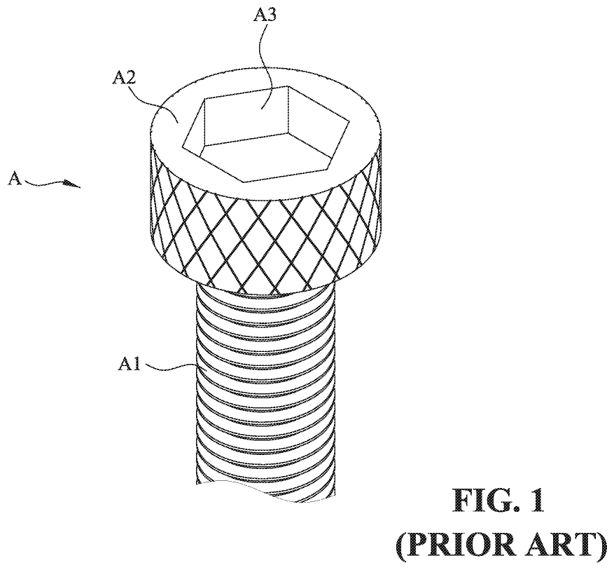

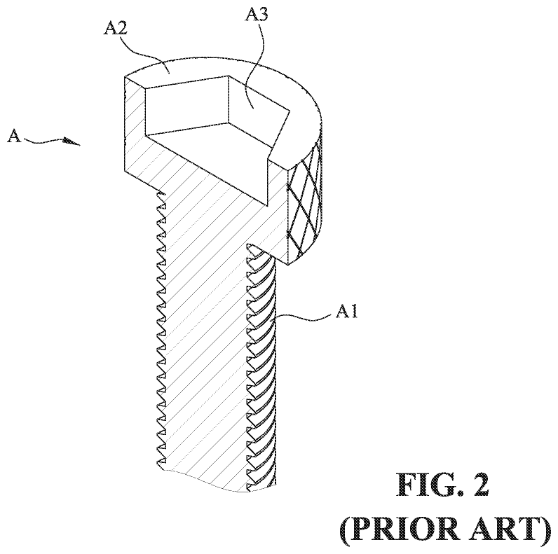

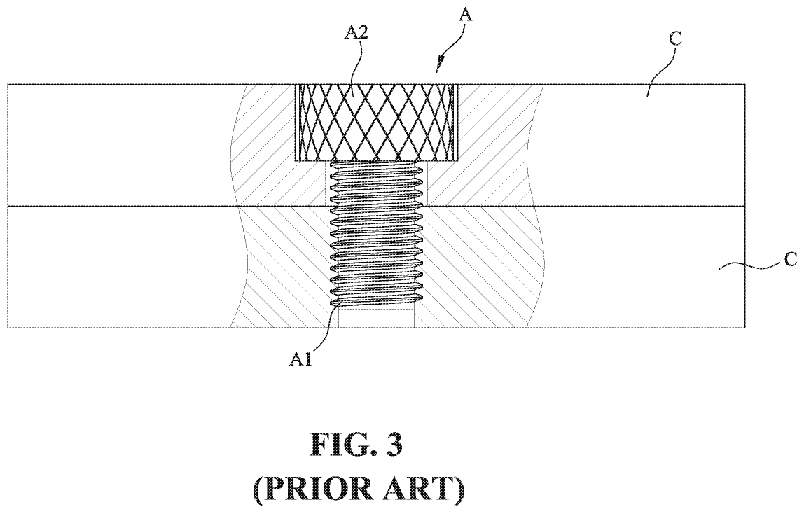

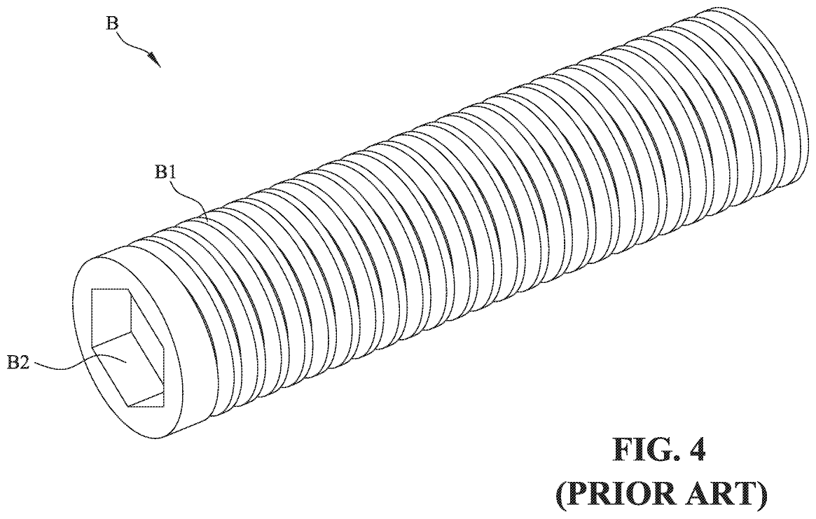

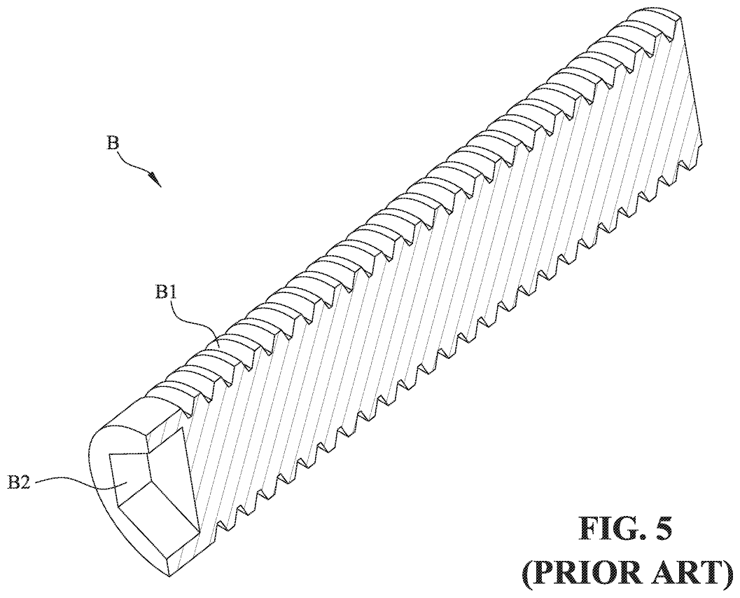

### DETAILED DESCRIPTION OF THE PREFERRED EMBODIMENT

The embodiments of the present invention will be described in more detail below with reference to the drawings and the component symbols, and the person skilled in the art may implement the present invention after studying the present specification.

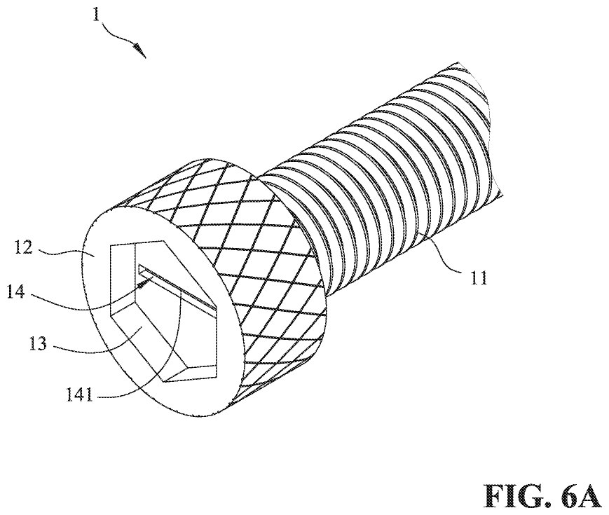

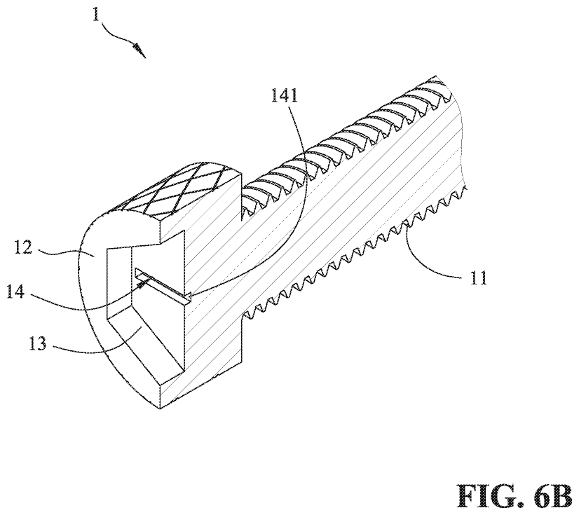

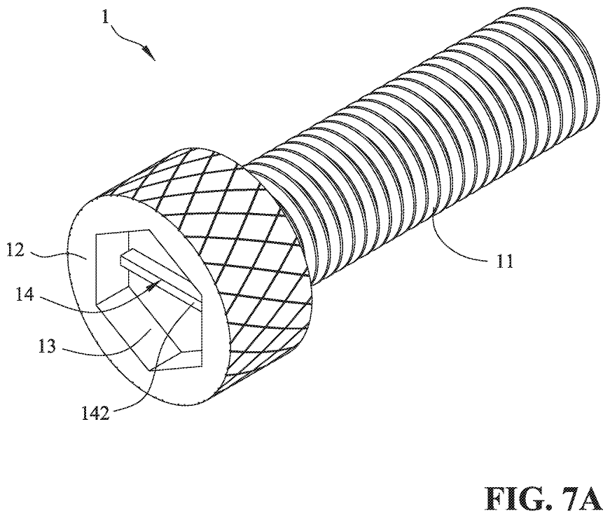

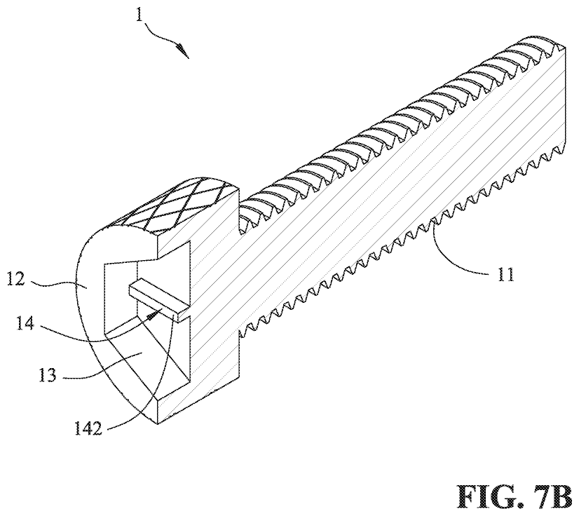

FIGS. 6A and 6B are respectively a perspective view and a perspective cross-sectional view showing a groove having a linear shape is formed on a bottom surface of a recess portion of a screw that has a head portion according to the present invention; and FIGS. 7A and 7B are respectively a perspective view and a perspective cross-sectional view showing a projection having a linear shape is formed on the bottom surface of the recess portion of the screw that has a head portion according to the present invention.

### First Embodiment

FIGS. 6A and 6B show the screw 1 according to the first embodiment of the present invention, wherein a head portion 12 is formed at one end of a spiral portion 11 of the screw 1, and an outer diameter of the head portion 12 is larger than an outer diameter of the spiral portion 11. A recess portion 13 is formed at an end surface of the head portion 12 by extending a depth along a central axis direction of the screw 1. A tool matching structure 14 is formed on the bottom surface of the recess portion 13 for providing a tool (not shown) that enters into the recess portion 13 so as to make a part of the tool and the tool matching structure 14 be matched to each other, thereby operating the tool to drive the screw 1 for rotating. More specifically, in the first embodiment shown in FIGS. 6A and 6B, the cross-sectional profile of the recess portion 13 may be formed in a hexagonal shape to constitute a hexagonal screw. Therefore, a correspondingly-shaped hexagonal wrench may be inserted into the recess portion 13 to drive the screw 1 for rotating. A linear groove 141 is formed on the bottom surface of the recess portion 13, so that a flat-head screwdriver (not shown) may be matched with the linear groove 141 to drive the screw 1 for rotating. The cross-sectional profile of the recess portion 13 may also be formed in other polygonal shapes, star shapes (not shown) or other geometric shapes to cooperate with a star wrench or other special tool to drive the screw for rotating.

### Second Embodiment

FIGS. 7A and 7B show the screw 1 according to the second embodiment of the present invention, wherein the head portion 12 is formed at one end of the spiral portion 11 of the screw 1, and the outer diameter of the head portion 12 is larger than the outer diameter of the spiral portion 11. The recess portion 13 is formed at an end of the head portion 12 by extending a depth along the central axis direction of the screw 1. The tool matching structure 14 is formed on the bottom surface of the recess portion 13 for providing a tool (not shown) that enters into the recess portion 13 so as to make a part of the tool and the tool matching structure 14 be matched to each other, thereby operating the tool to drive the screw 1 for rotating. More specifically, in the second embodiment shown in FIGS. 7A and 7B, the cross-sectional profile of the recess portion 13 may be formed in a hexagonal shape to constitute a hexagonal screw. Therefore, a correspondingly-shaped hexagonal wrench may be inserted into the recess portion 13 to drive the screw 1 for rotating. A linear protrusion 142 is formed on the bottom surface of the recess portion 13, so that a screwdriver (not shown) having a matching recess portion may be matched with the linear protrusion 142 to drive the screw 1 for rotating. The cross-sectional profile of the recess portion 13 may also be formed in other polygonal shapes, star shapes (not shown) or other geometric shapes to cooperate with a star wrench or other special tool to drive the screw for rotating.

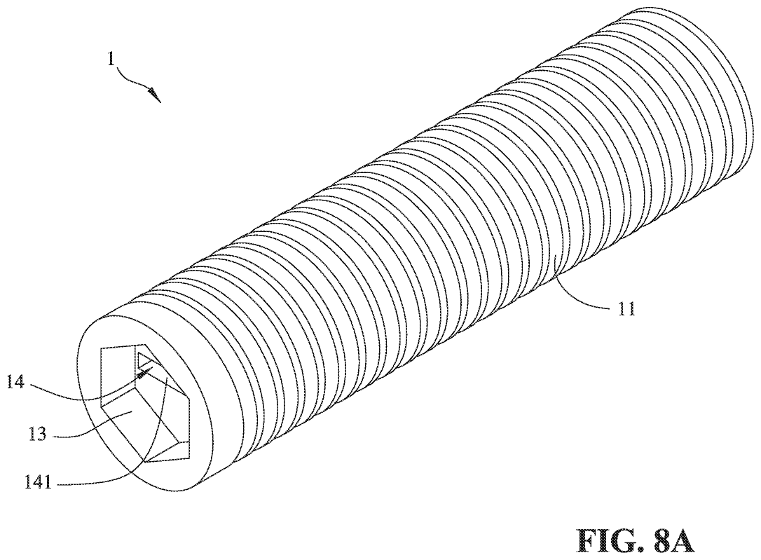

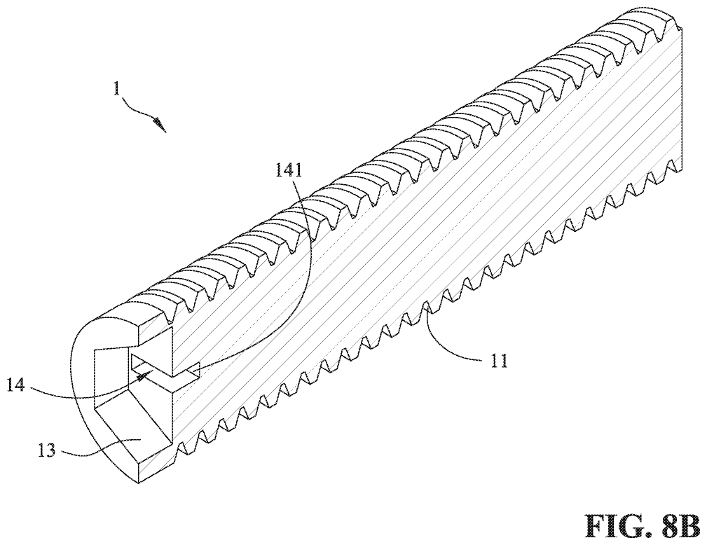

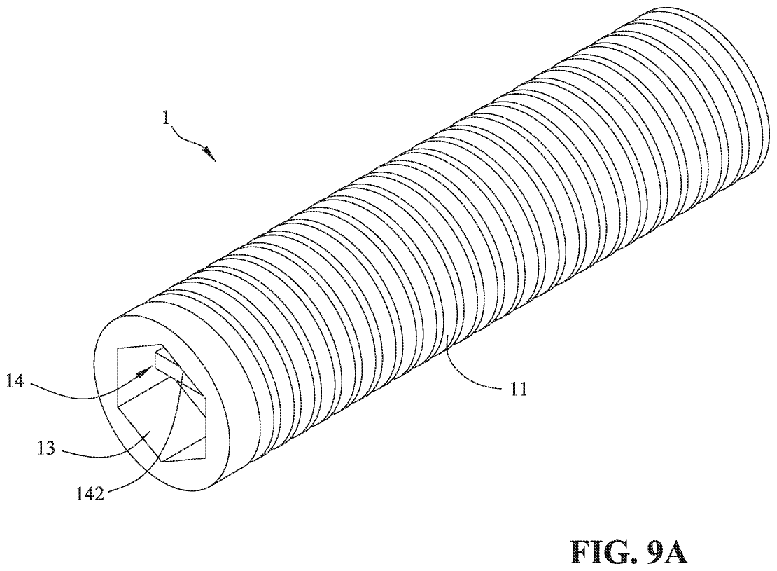

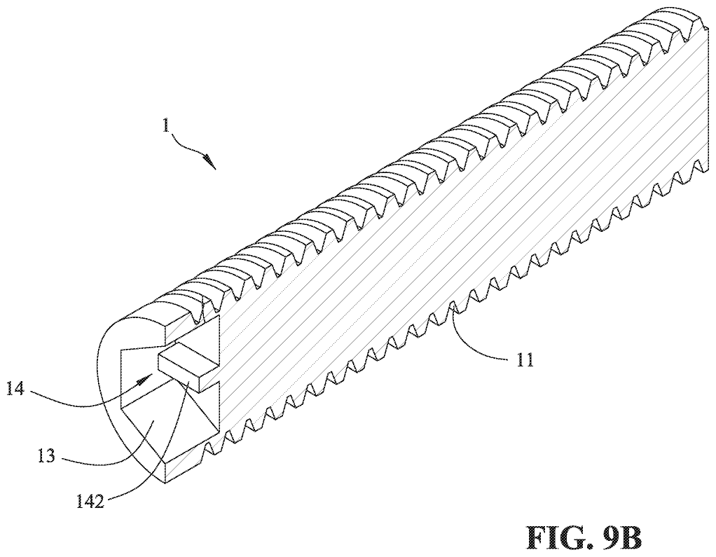

FIGS. 8A and 8B are respectively a perspective view and a perspective cross-sectional view showing a groove having a linear shape is formed on the bottom surface of the recess portion of the screw that has no head portion according to the present invention; and FIGS. 9A and 9B are respectively a perspective view and a perspective cross-sectional view showing a projection having a linear shape is formed on the bottom surface of the recess portion of the screw that has no head portion according to the present invention.

### Third Embodiment

FIGS. 8A and 8B show the screw 1 according to the third embodiment of the present invention, wherein the screw 1 includes the spiral portion 11 without a head portion. The recess portion 13 is formed at an end surface of the screw 1 by extending a depth along a central axis direction of the screw 1. The tool matching structure 14 is formed on the bottom surface of the recess portion 13 for providing a tool (not shown) that enters into the recess portion 13 so as to make a part of the tool and the tool matching structure 14 be matched to each other, thereby operating the tool to drive the screw 1 for rotating. More specifically, in the third embodiment shown in FIGS. 8A and 8B, the cross-sectional profile of the recess portion 13 may be formed in a hexagonal shape to constitute a hexagonal screw. Therefore, a correspondingly-shaped hexagonal wrench may be inserted into the recess portion 13 to drive the screw 1 for rotating. The linear groove 141 is formed on the bottom surface of the recess portion 13, so that a flat-head screwdriver (not shown) is matched with the linear groove 141 to drive the screw 1 for rotating. The cross-sectional profile of the recess portion 13 may also be formed in other polygonal shapes, star shapes (not shown) or other geometric shapes to cooperate with a star wrench or other special tool to drive the screw for rotating.

### Fourth Embodiment

FIGS. 9A and 9B show the screw 1 according to the fourth embodiment of the present invention, wherein the screw 1 includes the spiral portion 11 without a head portion. The recess portion 13 is formed at an end surface of the spiral portion 11 by extending a depth along a central axis direction of the screw 1. The tool matching structure 14 is formed on the bottom surface of the recess portion 13 for providing a tool (not shown) that enters into the recess portion 13 so as to make a part of the tool and the tool matching structure 14 be matched to each other, thereby operating the tool to drive the screw 1 for rotating. More specifically, in the fourth embodiment shown in FIGS. 9A and 9B, the cross-sectional profile of the recess portion 13 may be formed in a hexagonal shape to constitute a hexagonal screw. Therefore, a correspondingly-shaped hexagonal wrench may be inserted into the recess portion 13 to drive the screw 1 for rotating. The linear protrusion 142 is formed on the bottom surface of the recess portion 13, so that a screwdriver (not shown) having a matching recess portion may be matched with the linear protrusion 142 to drive the screw 1 for rotating. The cross-sectional profile of the recess portion 13 may also be formed in other polygonal shapes, star shapes (not shown) or other geometric shapes to cooperate with a star wrench or other special tool to drive the screw for rotating.

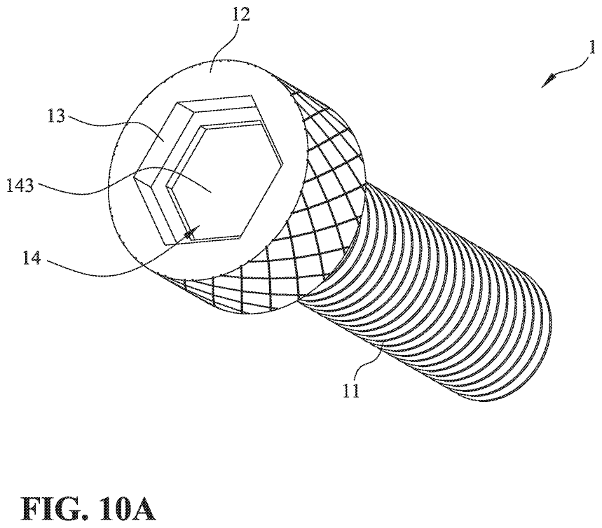

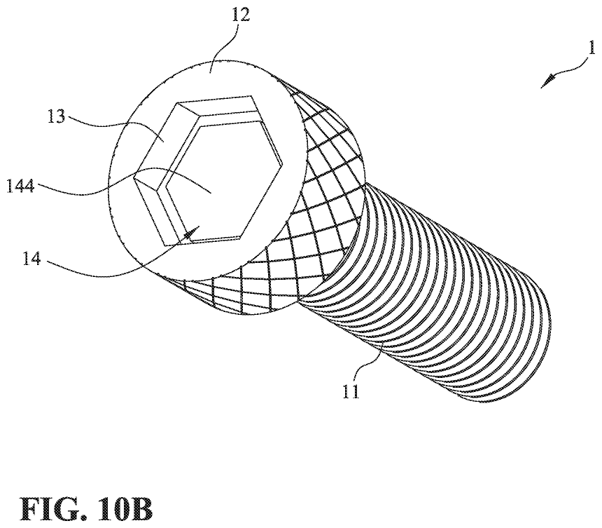

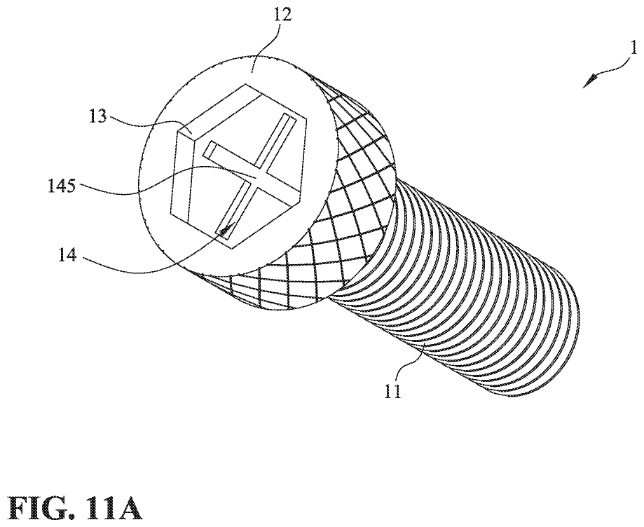

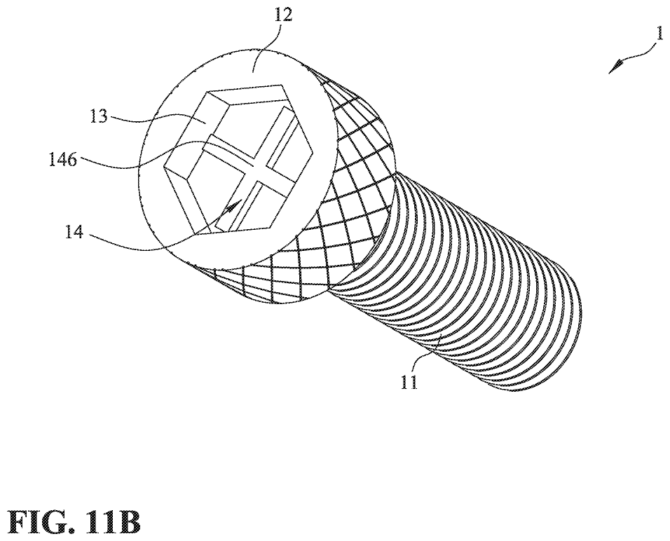

FIG. 10A is a partial perspective view showing a groove having a polygonal shape is formed on the bottom surface of the recess portion of the screw according to an embodiment of the present invention; FIG. 10B is a partial perspective view showing an embodiment, and a projection having a polygonal shape is formed on the bottom surface of the recess portion of the screw of the present invention; FIG. 11A is a partial perspective view showing a groove having a cross shape is formed on the bottom surface of the recess portion of the screw according to an embodiment of the present invention; and FIG. 11B is a partial perspective view showing a projection having a cross shape is formed on the bottom surface of the recess portion of the screw according to an embodiment of the present invention.

### Fifth Embodiment

FIG. 10A shows the screw 1 according to the fifth embodiment of the present invention, which includes a spiral portion 11 with or without a head portion 12 at one end thereof. A recess portion 13 may be formed at an end surface of the head portion 12 or an end surface of the spiral portion 11 by extending a depth along a central axis direction of the screw 1. A polygonal groove 143 is formed on the bottom surface of the recess portion 13 as the tool matching structure 14, thereby operating a screwdriver or a tool (not shown) having a matching protrusion that is matched to the polygonal groove 143 to drive the screw 1 for rotating.

### Sixth Embodiment

FIG. 10B shows the screw 1 according to the sixth embodiment of the present invention, which includes a spiral portion 11 with or without a head portion 12 one end thereof. A recess portion 13 may be formed at an end surface of the head portion 12 or an end surface of the spiral portion 11 by extending a depth along a central axis direction of the screw 1. A polygonal projection 144 is formed on the bottom surface of the recess portion 13 as the tool matching structure 14, thereby operating a screwdriver or tool (not shown) having a matching recess portion that is matched to the polygonal projection 144 to drive the screw 1 for rotating.

### Seventh Embodiment

FIG. 11A shows the screw 1 according to the seventh embodiment of the present invention, which includes a spiral portion 11 with or without a head portion 12 at one end thereof. A recess portion 13 may be formed at an end surface of the head portion 12 or an end surface of the spiral portion 11 by extending a depth along a central axis direction of the screw 1. A cross groove 145 is formed on the bottom surface of the recess portion 13 as the tool matching structure 14, thereby operating a cross-head screwdriver or tool (not shown) that is matched to the cross groove 145 to drive the screw 1 for rotating.

### Eighth Embodiment

FIG. 11B shows the screw 1 according to the eighth embodiment of the present invention, which includes a spiral portion 11 with or without a head portion 12 at one end thereof. A recess portion 13 may be formed at an end surface of the head portion 12 or an end surface of the spiral portion 11 by extending a depth along a central axis direction of the screw 1. A cross protrusion 146 is formed on the bottom surface of the recess portion 13 as the tool matching structure 14, thereby operating a cross-head screwdriver or tool (not shown) having a matching cross recess portion that is matched to the cross protrusion 146 to drive the screw 1 for rotating.

The tool matching structure 14 of the screw 1 of each of the foregoing embodiments may be integrally formed with the screw 1 by using a forging technique. For example, the mold for forming the tool matching structure 14 and the mold for forming the recess portion 13 may be integrated into one so that the recess portion 13 is formed in forging while the tool matching structure 14 is also formed on the bottom surface of the recess portion 13.

Through the aforementioned improved screw of the present invention, even when the recess portion 13 that is formed on the screw 1 for cooperation with a tool is worn or collapsed, it is also possible to use another tool such as a screwdriver to match the tool matching structure 14 to drive the screw 1 for rotating. Because the torque applied to the tool matching structure is small, it is suitable for fine-tuning the screw 1.

The above description is only for explaining the preferred embodiments of the present invention, and is not intended to limit the present invention. Therefore, any form of the changes should be included in the scope of the invention as claimed.

What is claimed is:

1. A screw, an end surface of which is formed with a recess portion by extending a depth along a central axis direction of the screw, wherein a tool matching structure is formed on a bottom surface of the recess portion for providing a tool that enters into the recess portion so as to make a part of the tool and the tool matching structure be matched to each other, thereby operating the tool to drive the screw for rotating.

2. The screw of claim 1, wherein one end of the screw has a head portion, and the recess portion is formed by extending the depth from an end surface of the head portion along the central axis direction of the screw.

3. The screw of claim 1, wherein a cross-sectional profile of the recess portion is formed in a polygonal shape.

4. The screw of claim 2, wherein a cross-sectional profile of the recess portion is formed in a polygonal shape.

5. The screw of claim 1, wherein a cross-sectional profile of the recess portion is formed in a star shape.

6. The screw of claim 2, wherein a cross-sectional profile of the recess portion is formed in a star shape.

7. The screw of claim 1, wherein the tool matching structure is a groove recessed from the bottom surface of the recess portion.

8. The screw of claim 1, wherein the tool matching structure is a protrusion protruding from the bottom surface of the recess portion.

9. The screw of claim 7, wherein the tool matching structure is a linear shape.

10. The screw of claim 8, wherein the tool matching structure is a linear shape.

11. The screw of claim 7, wherein the tool matching structure is a cross shape.

12. The screw of claim 8, wherein the tool matching structure is a cross shape.

13. The screw of claim 7, wherein the tool matching structure is a polygonal shape.

14. The screw of claim 8, wherein the tool matching structure is a polygonal shape.

15. The screw of claim 7, wherein the tool matching structure is a star shape.

16. The screw of claim 8, wherein the tool matching structure is a star shape.
